(19) United States
(12) Patent Application Publication
(10) Pub. No.: US 2002/0038236 A1
(43) Pub. Date: Mar. 28, 2002

(54) Systems and methods to allow voting for decision making

(76) Inventors: Stuart Schechter, Cambridge, MA (US); Robert Brooker, Marblehead, MA (US)

Correspondence Address: ROPES & GRAY, ONE INTERNATIONAL PLACE, BOSTON, MA, 02110-2624, US

(21) Appl. No.: 09/962,772

(22) Filed: Sep. 25, 2001

Related U.S. Application Data
(60) Provisional application No. 60/235,256, filed on Sep. 25, 2000.

(51) Int. Cl. G06F 17/60

(52) U.S. Cl. 705/12

(57) ABSTRACT

Systems and methods are provided that use voting rights to make decisions and to trigger a transaction in response to that decision. To this end, the systems may provide a site capable of allowing individuals in the group to vote for one of a plurality of decisions. The votes are tallied to identify the decision of the group. Program logic executes to process the election result to determine a transaction authorized by the group, and executing program logic, in response to the determination of an authorized transaction, to perform the transaction authorized by the group. In one particular application of these technologies, the systems operate as investment clubs that may be associated with a brokerage firm. Specifically, a brokerage firm may provide to its existing customers a platform for setting up an investment club wherein individuals may go on-line, open an account with the brokerage service and set up an on-line investment club. Optionally, other customers may be invited by the original investment club members to join the investment club by setting up an account with the on-line brokerage service and joining in discussions on how club funds should be allocated.

### REFERENCE TO RELATED APPLICATION

This application claims priority to an earlier filed provisional patent application of the same title, filed Sep. 25, 2000 and assigned U.S. Ser. No. 60/235,256, the contents of which are incorporated by reference herein.

### FIELD OF THE INVENTION

This invention relates to methods and systems for employing voting rights for decision making, and in one specific embodiment, to on-line investment clubs that provide club members or shareholders, with voting rights that may be employed for deciding, inter alia, between a plurality of possible investments.

### BACKGROUND OF THE INVENTION

Today, on-line brokerage firms are succeeding at an incredible rate. Of all the different applications that the Internet provides, probably the most successful has been the on-line purchase and sale of publicly traded stocks. Accordingly, the number of institutions that now offer on-line services for the sale and purchase of stocks continues to grow.

Although the growth of this industry indicates that it will be successful long-term, the success of the individual players in this space is more difficult to anticipate. Part of the reason for this difficulty is that the barrier to entry for competitive on-line brokerage firms is remarkably low and stock trading services are becoming a commodity. Accordingly, an on-line brokerage firm always stands a substantial risk that a new competitor will enter into their space and offer slightly better rates, or perform heavy marketing efforts, resulting in the loss of customers to the original on-line site.

Although a certain amount of customer fluidity is good and to be expected, the present churn rates for on-line brokers is remarkably high. Additionally, the acquisition costs for new customers can range from fifty dollars ($50.00) per customer to up to six hundred dollars ($600.00) per customer. Consequently, on-line brokerage firms need mechanisms for reducing churn rates and customer acquisitions costs.

To reduce customer churn, presently on-line brokerage firms turn to providing excellent content that instructs customers on how to invest wisely. Although such content is helpful to customers and all surveys indicate that the customers appreciate such content, the content itself is easily replicated by competitive brokerage services and provides little protection for the services client base. Accordingly, there is a need to provide on-line brokerage services with systems and methods to reduce customer churn and lower the cost of customer acquisition.

Today, the general population is faced constantly with simple decisions that need to be made, or would be better made, by the members of a group as opposed to an officer or other individual elected or appointed to make decisions for the members of the group.

### SUMMARY OF THE INVENTION

The systems and methods described herein include, among other things, systems and methods that use voting rights to make decisions and to trigger a transaction as a function of that decision.

In one particular application of these technologies, the systems described herein operate as investment clubs that may be associated with a brokerage firm. Specifically, a brokerage firm may provide to its existing customers a platform for setting up an investment club wherein individuals may go on-line, open an account with the brokerage service and set up an on-line investment club. Optionally, other customers may be invited by the original investment club members to join the investment club by setting up an account with the on-line brokerage service and joining in discussions on how club funds should be allocated.

In one particular embodiment, individual members of the investment club use voting to determine how club funds are to be allocated. Accordingly, a club member may post on a discussion board that a certain investment, typically a purchase or sale of stock, should be made by the club. Other club members can see this request when viewing the discussion boards associated with that investment club, or alternatively, the proposal may be e-mailed or otherwise delivered to members of the investment club. In either case, each club member will be provided with form, such as an HTML form, that includes components that will allow the club members to indicate whether they are for or against the proposal. The form can return the voting results from each member to the investment club server and the votes may be tallied. Depending upon the rules of the club as to how votes are to be made, the server can decide whether or not the investment has been ratified by the group. If so, the systems described herein may trigger the financial transaction to go forward.

It will be understood that the systems described herein provide features that may be provided by on-line brokers, or other businesses, to reduce churn and customer acquisition costs. By having club members open accounts at the on-line broker, and by using the on-line broker for financial transactions, the club members become accustomed to having their accounts serviced by that on-line broker. Moreover, in some optional practices for the investment club to leave a brokerage, the members must vote to leave. This creates a certain inertia that tends to keep the investment club with the brokerage. Additionally, as the members join the investment club by invitation from existing members, the system employs a viral marketing effect for the brokerage, and thereby reduces customer acquisition costs.

More specifically, the invention includes, among other things, processes for performing a transaction requiring authorization from a group of individuals. The processes may include providing a site capable of allowing individuals in the group to vote for one of a plurality of decisions, tallying the votes to identify an election result representative of a decision by members of the group, executing program logic to process the election result to determine a transaction authorized by the group, and executing program logic, in response to the determination of an authorized transaction, to perform the transaction authorized by the group.

Optionally, the processes may also involve providing a database having stored therein a set of rules representative of rules for governing the tallying of votes, wherein votes are tallied according to the set of rules to determine the election result. In this way, rules may be stored as data records within a database and employed by the systems and methods described herein to implement voting procedures for the group. These voting procedures may be selected for the group, either by default or upon an initial selection by the founders of the group. Alternatively, these rules may be established and amended on an on-going basis by action of the group.

Optionally, the executing program logic may include program logic for accessing an on-line brokerage account to execute a financial transaction. Any financial or legal transaction may be undertaken, and such transactions will include, but not be limited to, financial transactions selected from the group consisting of selling a security, buying a security, holding a security, selling a property, buying a property, holding a property, opening an account at a brokerage, setting an asset allocation, selecting a level of investment risk and selecting an investment advisor.

Similarly and optionally, the groups that may employ such services and system described herein may include any type of group, whether a recognized legal entity or not, and will include, but not be limited to groups selected from the group consisting of a partnership, a corporation, a limited liability corporation, a non-profit organization, a legal trust, a pool of heirs, and a class of plaintiffs.

As will be described below, the processes and systems of the invention may be implemented with any suitable technology, including but not limited to a web site for allowing an HTTP compliant client to exchange information over a network. Any suitable network may be employed including networks selected from the group of networks comprising a LAN, a WAN, a wireless network, and a cable network. In optional embodiments a site may include program logic for delivering e-mail notification of pending elections to individuals in the group. These types of e-mail notification systems, including e-mail notifications that include links to on-line sites, are known in the art, and any suitable such systems may be employed. Further optionally, the processes may allow an individual of the group to vote anonymously.

In further aspects, the systems and methods of the invention include, processes for marketing a brokerage service, comprising providing an on-line service for allowing a group of account holders of a brokerage service to form an investment club, the on-line service having a site capable of allowing account holders in the group to vote for one of a plurality of investment decisions. The site may further have program logic for tallying the votes to identify an election result representative of a decision by account holders in the group, and program logic to process the election result to determine a transaction authorized by the group. Additionally, the site any have program logic for executing responding to the election result to implement a financial transaction through the brokerage service to thereby perform the transaction authorized by the group. In this process, optionally, the process will allow the group of account holders to open a group account for receiving funds available to the group to employ for transactions related to the group. Alternatively, and perhaps jointly, the process will allow each account holder to establish an account for receiving funds for that account holder and for managing those funds according to a decision made by the group.

Additionally, in another aspect the systems and methods described herein include an on-line system for allowing individuals to elect between a plurality of choices and to perform an elected transactions. The systems may comprise a server capable of exchanging information over a data network and capable of allowing individuals in the group to vote for one of a plurality of decisions, program logic for tallying the votes to identify an election result representative of a decision by members of the group, program logic for processing the election result to determine a transaction authorized by the group, and program logic, that operates in response to the determination of an authorized transaction, for performing automatically the transaction authorized by the group. Optionally, the on-line system may include a database for storing a set of rules representative of rules for governing the logic for tallying the votes.

The transaction authorized by these voting systems can include any type of transaction, including, but not limited to, transactions selected from the group consisting of buying a security, holding a security, selling a security, and setting an asset allocation, where that asset allocation identifies, for example, a percentage of the investable assets that are to be put in securities, versus bonds, versus cash. Other examples of asset allocation are known to those of skill in the art, and any asset allocation type may be employed with the systems described herein.

Other additions and modifications to this system and methods will be set forth below, being apparent to those of ordinary skill in the art.

Other objects of the invention will, in part, be obvious, and, in part, be shown from the following description of the systems and methods shown herein.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts one system according to the invention wherein an on-line brokerage service provides an investment club service to customers of that brokerage;

FIG. 2 depicts schematically the voting process for the system depicted in FIG. 1;

FIG. 3 depicts a flow chart diagram of one process according to the invention;

### DESCRIPTION OF CERTAIN ILLUSTRATED EMBODIMENTS

To provide an overall understanding of the invention, certain illustrative embodiments will now be described. However, it will be understood by one of ordinary skill in the art that the systems and methods described herein may be adapted and modified for other suitable applications and that such other additions and modifications will not depart from the scope hereof.

The systems and methods described herein employ voting rights to make decisions. In one application, condominium associations employ such systems to allow individual condominium members to vote how the condominium association should allocate funds, take actions, or otherwise run the condominium association. Charities and foundations may also use the voting systems described herein for determining the allocations of funds and other types of decisions. Proxy voting may be supported, as well as voting within partnerships such as partnerships of law firms, consulting companies, and other partnerships. In one particular embodiment, the systems and methods described herein may be employed for allowing on-line investment clubs to operate in a manner wherein individual members, or shareholders, of the investment club vote as to how funds are to be disbursed as well how rules and decisions are to be made in the investment club. Such rules and decisions can include who is allowed, or otherwise invited to join the club, whether a simple majority will be sufficient to act on a vote or if other conditions or voting structures are to be employed, alternative structures for the officers of the investment company including new positions and elections for club officers, and any other type of decision that may be made by the investment club during the running of that organization.

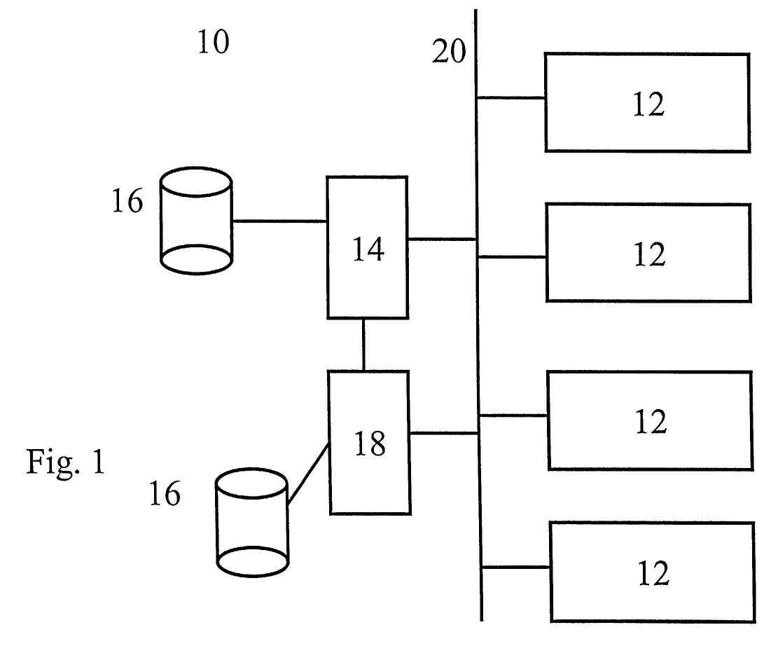

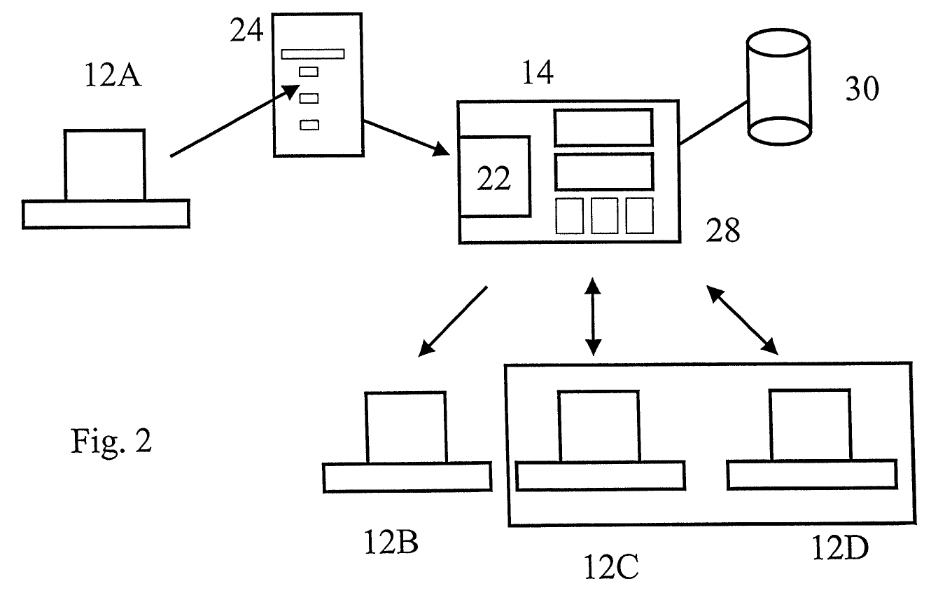

FIGS. 1 and 2 depict one system 10 according to the invention wherein a plurality of customers 12 of an on-line brokerage firm having a brokerage server 18 are provided by the brokerage firm with access to an on-line investment club server 14 for supporting an investment club. In the embodiment depicted in FIG. 1 the brokerage server 18 is depicted as separate from the investment club server 14 to indicate that these investment club services may be outsourced to an ASP or other provider. However, in other embodiments the investment club server may be integrated into or run by the brokerage service. In the embodiment of FIG. 1 the network 20 that couples the customers 12 with the servers 18 and 14 is contemplated to be the Internet computer network, however, any type of network, including any LAN or WAN, may be employed for supporting the systems and methods described herein. This may also include networks that support wireless data communication.

The system 10 depicted in FIG. 1 may comprise conventional data processing and networking components, and special hardware is not required. For example, the server 14 may comprise a commercially available server platform such as a Sun Sparc™ system running a version of the Unix operating system and running a server program capable of connecting with, or exchanging data with, one of the subscriber systems 12. In the embodiment of FIGS. 1 and 2, the server 14 includes a web server 22, such as the Apache web server. The web server component of the server 14 acts to listen for requests from customer systems 12, and in response to such a request, resolves the request to identify a filename, script, or dynamically generated data that can be associated with that request and returned to the requesting customer 12.

The web server 22 typically serves web pages. The web pages can be typical web pages of the type that are commonly written in HTML (hypertext markup language) and XML (extensible markup language). Additionally, the Web pages may be written as active server pages, or “asp” text files, using the active server page technology from Microsoft Corporation. An active server page allows a user to write Web pages using a combination of a hypertext language (e.g., HTML) and a scripting language, such as Visual Basic from Microsoft Corporation or Java from Sun Microsystems. Active server pages are described in documentation available from Microsoft's Web site “www.microsoft.com”, currently under the section Internet Information Services. As is known to those of skill in the art, the Web pages are transmitted using conventional network protocols, such as TCP/IP (Transmission Control Protocol/Internet Protocol), HTTP (Hypertext Transfer Protocol) and DCOM (Distributed Component Object Model). The client-based browser, or other application, renders the Web page into human perceptible forms. The Web page might include text, images, sound, video, active code, and so forth. The operation of the web server component of server 14 can be understood more fully from Laurie et al., Apache The Definitive Guide, O'Reilly Press (1997). The development of web pages is known to those of skill in the art and are described in detail in public references, including Ian Graham, HTML Sourcebook, Wiley Computer Publishing (1997) the teachings of which are herein incorporated by reference.

The server 14 may also include components that extend its operation to accomplish the financial transactions desired by the investment club, and the architecture of the server 14 may vary according to the application. For example, the web server may have built in extensions, typically referred to as modules, to allow the server 14 to perform operations that facilitate the financial transactions desired by the investment club, or the web server may have access to a directory of executable files, each of which files may be employed for performing the operations, or parts of the operations, that implement the desired financial transactions. Thus it will be understood that the server 14 may act as a financial transaction server according to the invention that configures the workstation hardware supporting the server 14 to act as a system according to the invention.

In the depicted embodiment, the server 14 couples to a database 16 that stores information representative of a member's account, or investment club account, including information about the subscribers' accounts, including passwords, user accounts, user privileges and similar information. The depicted database 16 may comprise any suitable database system, including the commercially available Microsoft Access database, and can be a local or distributed database system. The design and development of database systems suitable for use with the system 10, follow from principles known in the art, including those described in McGovern et al., A Guide To Sybase and SQL Server, Addison-Wesley (1993). The database 16 can be supported by any suitable persistent data memory, such as a hard disk drive, RAID system, tape drive system, floppy diskette, or any other suitable system. Optionally, all customer information may be maintained on the brokerages site in the database 16. Optionally, the server 14 connects by direct secure lines to the server for the on-line brokerage 18.

For the depicted system 10, the client systems 12 can be any suitable computer system such as a PC workstation, a handheld computing device, a wireless communication device, pagers, Web-phones, set-top boxes for TVs, or any other such device, equipped with a network client capable of accessing a network server and interacting with the server to exchange information with the server. In one embodiment, the network client is a web client, such as a web browser that can include the Netscape web browser, the Microsoft Internet explorer web browser, the Lynx web browser, or a proprietary web browser, or web client that allows the user to exchange data with a web server, an ftp server, a gopher server, or some other type of network server. Optionally, the client and the server rely on an unsecured communication path, such as an HTTP Internet path, for accessing services on the remote server. To add security to such a communication path, the client and the server may employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Therefore, optionally, the client systems 12 and the server system 14 have built in 128 bit or 40 bit SSL capability and can establish an SSL communication channel between the clients 12 and the server 14.

Turning to FIG. 2, one process for allowing an investment club member to propose a vote to the other members of the group is depicted schematically. Specifically, FIG. 2 depicts a situation wherein the club member 12A accesses the web server 22 of the server 14. The web server 22 may provide to the member 12A an HTML page 24 that the member 12A can edit for the purpose of submitting a proposal to the other members of the club. As shown in FIG. 2, the completed HTML form 24 may be delivered to the web server 22. At the web server 22 application programs executing on the server 14 process the information provided by the member 12A and extract the proposal provided by the member 12A and publish it to the rest of the group members 12B, 12C and 12D respectively.

For example, in one practice each time an investment club is established, a default set of club by-laws is provided to that club. The default by-laws may include that all votes on any decision shall be decided by a simple majority and that a quorum of members will be satisfied anytime a majority of the members have voted. In the example depicted in FIG. 2, the customer 12A may be proposing a change to the by-laws. For example, the customer 12A may be proposing that votes to purchase more than $10,000 of stock in a particular company be ratified by a two-thirds majority of the club members. In one practice, the server 14 has a plurality of web pages 28, each of which can be associated with a common type of operation or vote performed by investment club members. Continuing with this example, the server 14 may have a plurality of web pages associated with common modifications made to the by-laws. To that end, one of the HTML pages may include a set of modifications commonly made to the by-laws. The server 14 may allow the user 12A to select among different web pages until the customer 12A finds the web page that includes the form for making common modifications to the by-laws. The web page 28 may be delivered by web server 22 to the client 12A. The client 12A can enter the proposed modifications such as by finding a field that allows the voting majority to be changed from a simple majority to two-thirds. Once the customer 12A has completed entering the proposed modifications to the by-laws, the form is delivered back to the web server and the server 14 publishes the proposed changes to each of the other club members 12B, 12C and 12D.

In the process depicted by FIG. 2, the server 14 publishes the proposed rule change to each of the other club members 12B, 12C, 12D. However, in this depicted practice only members 12C and 12D are shareholders in the club; 12B is merely a member. The distinction between being a shareholder and being a member may be that members are persons who have joined the club while shareholders are those that have placed funds within the club's treasuries for being allocated into club investments. In the practice depicted by FIG. 2, each of the club members 12B, 12C, 12D are published the proposed modifications to the by-laws however only those members that are also shareholders are allowed to reply to or vote on the proposals. This is depicted in FIG. 2 by the bi-directional arrows that connect customers 12C and 12D to the sever 14.

Once customers 12C and 12D have voted the server 14 may tally the results according to the by-laws and post the results for view. Simultaneously, the server 14 may make the amendments to the by-laws and the decisions henceforth will be made by the server according to the new by-laws. Modifications to the by-laws may be stored within the database 30 depicted in FIG. 2 which can store information about the club portfolio, individual club members, by-laws, and other such information. From the above description, it can be seen that customers may be assigned to different groups. For example, the customers associated with the club depicted in FIG. 2 may be members of the club member group, as well as members of a club shareholder group. The system described herein can optionally employ a hierarchical grouping structure that allows groups to be formed from groups. Thus, the shareholders of a set of groups can be, for certain purposes, placed in a new group. Once this group is established, the members of the group employ voting to determine what powers and functions the members of this new group are to have.

In one optional practice of the process depicted in FIG. 2, the server 14 may publish proposed rule changes and investments by e-mail messages to each of the club members. The link may be provided within the e-mail message to an HTML page that the customers may employ for voting on the proposal. Optionally, the users may also reply to the e-mail and include within their reply messages regarding their comments on the proposal. In this practice, each e-mail message is provided with a unique identification string in the reply-to address of the header such that a return mail will return this string directly to the mail server when the message is replied to. Accordingly, when the e-mail is returned to the mail server on the server 14 the string may carry the message I.D., that may be a hash of the I.D. of the user that was sent the message as well as the discussion to which the message corresponds, as well as other optional factors, which may be processed by the mail server to know where to locate the delivered comments and the identity of the author. Once the mail server identifies the proper discussion board the e-mail server may post the e-mail contents to the associated thread.

In either case, once a decision is made, the systems and methods described herein can execute a script that carries out the decision by implementing the transaction elected by the group. The type of script employed by the systems and methods of the invention may be any suitable scripts or executable file. One such executable file may be a script that automatically implements the elected decision, by for example contacting the broker server and executing the transaction, such issuing the server a request to buy or sell a security. The executable file may be a Perl V script, a C language program, a web server module or any other suitable program for providing a process that can implement the elected transaction or transactions. The design and development of such scripts and executable files follows from principles known in the art of computer programming, including those set forth in Wall et al., Programming Perl, O'Reilly & Associates (1996); and Johnson et al, Linux Application Development, Addison-Wesley (1998). Additionally, in other embodiments, the executable file that carries out a transaction may be implemented, at least in part, by employing the operating system to restrict the execution of certain scripts and to restrict access to certain files by configuring the operating system in a selected manner. Techniques for so configuring the operating system are known in the art, including those techniques set forth in Bach, The Design of the Unix Operating System, Prentice-Hall (1986).

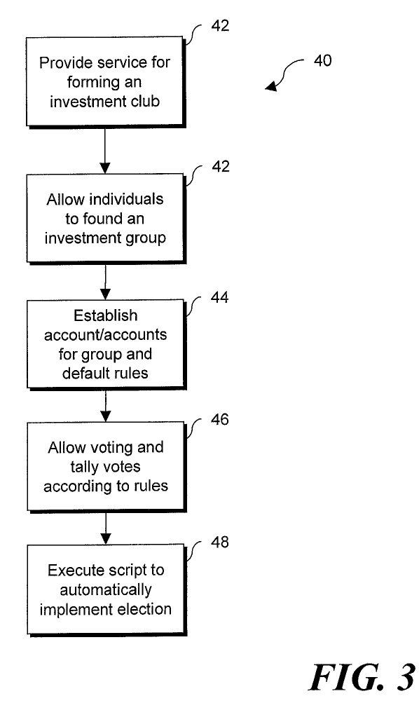

FIG. 3 depicts one process 40 according to the invention for allowing a brokerage service to employ a voting based decision system that automatically implements elections to market brokerage services. Specifically, FIG. 3 depicts a process 40 that begins in block 42 wherein the brokerage service, or some other suitable entity, provides an on-line site for allowing individuals to form an investment club, or some other group that is suited to the particular application, such as condo association. The manner in which the service is provided may vary, and may include the brokerage contracting with a third party service that offers the service though an ASP model, or by building the system into the brokerage service directly. After block 42, the process 40 proceeds to block 42 wherein the brokerage service allow the individuals to found a group. In the process 40, the process then goes to block 44 wherein the new group is provided with a set of rules for determining how to tally votes and to set up the set of rules that govern how rules are counted, tallyed, and how an election or election is made from the plurality of choices. Other rules may also be provided for controlling how members are accepted, or rules are changed. The rules may be stored in a database, with each club having a different set of rules, optionally. The rules for each particular club may be identified or keyed within the database by providing a group ID field that associates the set of rules with one or more groups.

The process 40 in block 46 allows for voting and will tally the votes according to the rules. Once votes are tallyed, then the decision of the group may be identified. Optionally, more than one election may be made from the offered choices. Once the election(s) is made, the process 40 may invoke at block 48 the appropriate script that will allow for automatic implementation of the elected choice. This may include the automatic placing of a buy or sell order, or the allocation of assets among different classes of assets.

The systems and methods described above will also be seen to provide investment clubs that may use voting rights to determine how investments should be made as well as other decisions about how the clubs should be run. Optionally, the systems described herein may include an on-line voting scheme with short circuitry, wherein once enough votes are in to make a decision the vote is over. In this embodiment, individual club members do not have to wait for all members to vote. Optionally, the allocation of voting rights may be determined by conditions other than whether a person is a member of a club, or a shareholder in a club. For example in certain optional embodiments, the voting right provided to a club member may be earned in part on that club member's past performance or voting record. Thus, performance based voting rights may be provided. Additionally, in optional embodiments the decision process specification system allows a customer to specify decision-making processes using a number of steps. The criteria that may be met for a step to pass are, for example:

1) A vote requiring a set percent of shares or members of a group (all groups may be hierarchical groups);

2) Approval of a fixed number of members of a group may be as small as one approval from a group of size one, equivalent to saying President must approve or customer X (an officer) must approve);

3) A logical combination (AND or OR) of any number of criteria of these three forms. When a step passes or fails, it may be specified to launch another step or pass or fail the decision.

In further optional practices to avoid the problem with insider trading that may arise, club members may have the right to select certain stocks from which they will abstain from receiving information, providing information or voting. Additionally, any votes made by club members may be archived by the server 14 for later use.

Although the above figures graphically depict the server systems of the invention as functional block diagrams composed of different functional block elements, it will be apparent to one of ordinary skill in the art that these elements can be realized as computer programs or portions of computer programs that are capable of running on the data processor platform to thereby configure the data processor as a system according to the invention.

The systems and methods discussed above can be realized as a software components, typically one or application programs or executing computer processes, operating on a conventional data processing system such as a Unix or Windows bases computer platform. In these embodiments, the systems can be implemented as a C language computer program, or a computer program written in any high level language including C++, Fortran, Java or Basic. The development of such programs is known to those of skill in the art, and general techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. For example, the systems and methods described herein may include systems and methods that allow a group of individuals to act as the executor of an estate or a trustee for a trust. In both these cases, as well as others, certain financial decisions need to be made. To this end, the systems and methods described herein may include systems and methods wherein a group of people may be selected to be the executor/trix of a will. In this embodiment, the will may provide for certain rules that describe how decisions may be made by the group. In these embodiments the estate may be administered by a group of people more easily than prior systems that relied on a human executor/trix.

Accordingly, it will be understood that the invention is not to be limited to the embodiments disclosed herein, but is to be understood from the following claims, which are to be interpreted as broadly as allowed under the law.

We claim:

1. A process for performing a transaction requiring authorization from a group of individuals, comprising
providing a site capable of allowing individuals in the group to vote for one of a plurality of decisions,
tallying the votes to identify an election result representative of a decision by members of the group,
executing program logic to process the election result to determine a transaction authorized by the group, and
executing program logic, in response to the determination of an authorized transaction, to perform the transaction authorized by the group.

2. A process according to claim 1, further comprising
providing a database having stored therein a set of rules representative of rules for governing the tallying of votes, wherein votes are tallied according to the set of rules to determine the election result.

3. A process according to claim 1, wherein executing program logic includes Executing program logic for accessing an on-line brokerage account to execute a financial transaction.

4. A process according to claim 3, wherein the executed financial transaction is selected from the group consisting of selling a security, buying a security, holding a security, selling a property, buying a property, holding a property, opening an account at a brokerage, setting an asset allocation, selecting a level of investment risk and selecting an investment advisor.

5. A process according to claim 1, wherein the group of individuals includes a group selected from the group consisting of a partnership, a corporation, a limited liability corporation. a non-profit organization, a legal trust, a pool of heirs, and a class of plaintiffs.

6. A process according to claim 1, wherein executing program logic includes executing program logic to exchange information with a brokerage server for performing the financial transaction through the associated brokerage.

7. A process according to claim 1, wherein
Providing a site includes providing a web site for allowing an HTTP compliant client to exchange information.

8. A process according to claim 1, wherein
Providing a site includes providing a site having access over network selected from the group of networks comprising a LAN, a WAN, a wireless network, and a cable network.

9. A process according to claim 1, wherein
Providing a site includes providing a site having program logic for delivering e-mail notification of pending elections to individuals in the group.

10. A process according to claim 1, further comprising
Allowing an individual of the group to vote anonymously.

11. A process according to claim 1, further comprising
Providing program logic for allowing the group to alter a set of rules stored in a database and being representative of rules for governing a procedure for holding elections to make decisions by the group.

12. A process for marketing a brokerage service, comprising
Providing an on-line service for allowing a group of account holders of a brokerage service to form an investment club, the on-line service having
a site capable of allowing account holders in the group to vote for one of a plurality of investment decisions,
program logic for tallying the votes to identify an election result representative of a decision by account holders in the group,
program logic to process the election result to determine a transaction authorized by the group, and
program logic for executing responding to the election result to implement a financial transaction through the brokerage service to thereby perform the transaction authorized by the group.

13. A process according to claim 12, further comprising
Allowing the group of account holders to open a group account for receiving funds available to the group to employ for transactions related to the group.

14. A process according to claim 12, further comprising
Allowing each account holder to establish an account for receiving funds for that account holder and for managing those funds according to decisions made by the group.

15. A process according to claim 12, further comprising
Allowing a group to increase the number of account holders in the group by inviting individuals to become new account holders.

16. An on-line system for allowing individuals to elect between a plurality of choices and to perform an elected transactions, comprising
a server capable of exchanging information over a data network and capable of allowing individuals in the group to vote for one of a plurality of decisions,
program logic for tallying the votes to identify an election result representative of a decision by members of the group,
program logic for processing the election result to determine a transaction authorized by the group, and
program logic, in response to the determination of an authorized transaction, for performing automatically the transaction authorized by the group.

17. An on-line system according to claim 16, further comprising
a database for storing a set of rules representative of rules for governing the logic for tallying the votes.

18. An on-line system according to claim 16, wherein the transaction authorized from the group includes a transaction selected from the group consisting of buying a security, holding a security, selling a security, and setting a asset allocation.
